(19) United States
(12) Patent Application Publication
(10) Pub. No.: US 2024/0185318 A1
(43) Pub. Date: Jun. 6, 2024

(54) FUEL-CELL SECONDARY-USE DETERMINATION SYSTEM AND FUEL-CELL SECONDARY-USE DETERMINATION METHOD

(71) Applicant: HONDA MOTOR CO., LTD., Tokyo (JP)

(72) Inventor: Seiji SUGIURA, Saitama (JP)

(21) Appl. No.: 18/552,905

(22) PCT Filed: Mar. 28, 2022
(86) PCT No.: PCT/JP2022/014957

§ 371 Date: Sep. 28, 2023

(30) Foreign Application Priority Data
Mar. 30, 2021 (JP) 2021-057950

(51) Int. Cl. G06Q 30/0601; H01M 8/008

(52) U.S. Cl. CPC G06Q 30/0611; H01M 8/008

(57) ABSTRACT

The purpose of the present invention is to provide a technology that makes it possible to evaluate a reuse value on the basis of the state of degradation of a fuel cell. A fuel-cell secondary-use determination system 1 is provided with: a seller-input-information accepting unit 27 that accepts seller input information from a seller, the seller input information including individual item information including a type and an identifier of a fuel cell put up for sale, usage period information thereof so far, output performance information including the current output thereof, and degradation information thereof; and a remaining-value determination unit 22 that determines the remaining value of the fuel cell put up for sale on the basis of the usage period information, the output performance information, and the degradation information.

### TECHNICAL FIELD

The present invention relates to a fuel-cell secondary-use determination system and a fuel-cell secondary-use determination method.

### BACKGROUND ART

A system of determining a criterion for calculating a fee relating to a secondary battery has been proposed (for example, see Japanese Unexamined Patent Application, Publication No. 2018-063632). The system disclosed in Japanese Unexamined Patent Application, Publication No. 2018-063632 includes: a remaining-capacity detector that detects a remaining capacity of a secondary battery; a time-series-data storage that stores time series data in which the remaining capacity and a point in time of the detection are associated with each other; a use-evaluation identifying unit that, when at least one condition of a degradation suppression condition or a degradation facilitation condition is set beforehand, determines if a change in the remaining capacity, which is acquired from the time series data, satisfies the at least one condition, and identifies a use evaluation based on a result of the determination; and a calculation-criterion determining unit that determines a fee calculation criterion in accordance with the use evaluation based on a determination criterion set beforehand.

In the system disclosed in Japanese Unexamined Patent Application, Publication No. 2018-063632 described above, changes in remaining capacity include changes in capacity of discharged electric power and capacity of charged electric power in a certain period and changes in capacity of discharged electric power and capacity of charged electric power in a certain state of charge (SOC). With this configuration, it is possible to evaluate a tendency of use by a user using a characteristic of a battery based on time series changes in remaining capacity and a degradation suppression condition or a degradation facilitation condition to determine a fee calculation criterion. Therefore, it is said that it is possible to provide, to the user, a motivation of using a battery in such a manner that leads to suppression of degradation.
Patent Document 1: Japanese Unexamined Patent Application, Publication No. 2018-063632

### DISCLOSURE OF THE INVENTION

### Problems to be Solved by the Invention

However, a state of degradation and its factors differ between a secondary battery and a fuel cell. In a fuel cell, generally, electrodes degrade, and electrolyte films degrade, in accordance with its period of time of use. As the electrolyte films degrade, a fuel gas and an oxidant gas may eventually cross leak. The fuel cell in which a cross leak has occurred can no longer be used. Therefore, a technology that makes it possible to evaluate a reuse value of a fuel cell based on a state of degradation of the fuel cell has been demanded.

In view of those issues described above, an object of the present invention is to provide a technology that makes it possible to evaluate a reuse value of a fuel cell based on a state of degradation of the fuel cell.

### Means for Solving the Problems

(1) The present invention provides a fuel-cell secondary-use determination system (for example, fuel-cell secondary-use determination systems 1 and 1A described later) including: a seller-input-information acceptor (for example, a seller-input-information acceptor 27 described later) that accepts, from a seller, seller input information, which includes individual item information including a type and an identifier of a fuel cell offered for sale, information on a usage period to date, information on output performance including a present output capability, and information on degradation; and a remaining-value determiner (for example, a remaining-value determiner 22 described later) that determines a remaining value of the fuel cell offered for sale based on the information on the usage period, the information on the output performance, and the information on the degradation.

According to the invention described in (1), it is possible to determine a remaining value based on a state of degradation per fuel cell offered for sale, making it possible to appropriately evaluate a reuse value of the fuel cell. It is known that an actual life and durable years of a fuel cell largely depends on its use history, operation environment, and other factors pertaining to the fuel cell, for example. There is a possibility that even a fuel cell having just passed its durable years set beforehand still has a remaining value at that point in time. Discarding such a fuel cell still having a remaining value based on a fact that its life and durable years set beforehand have just passed wastes the remaining value, leaving some issues in terms of effective use of resources. In response to these issues, according to the invention described in (1), it is possible to determine a reuse value of a used fuel cell when the used fuel cell is to be reused, making it possible to select an appropriate fuel cell in accordance with a place of reuse. Eventually, according to the invention described in (1), even when a fuel cell having passed its durable years as a vehicle fuel cell is diverted for its application to a stationary application, for example, it is possible to easily select a place of reuse and to set a selling price by an intermediary agent.

(2) The fuel-cell secondary-use determination system described in (1) may further include: a user-input-information acceptor (for example, a user-input-information acceptor 28 described later) that accepts, from a user, user input information, which includes information on a requested output capability for a fuel cell; and a matching processor (for example, a matching processor 24 described later) that selects, when the present output capability of the fuel cell offered for sale satisfies the requested output capability provided by the user, the fuel cell offered for sale as a matching candidate.

According to the invention described in (2), it is possible to select a fuel cell offered for sale, which offers a present output capability satisfying a requested output capability provided by a user, as a matching candidate, allowing the user to select an appropriate fuel cell satisfying the requested output capability from among the matching candidates.

(3) The fuel-cell secondary-use determination system described in (2) may further include a usable-period estimator (for example, a usable-period estimator 25 described later) that estimates a usable period of the fuel cell offered for sale based on the individual item information and the information on the degradation, in which the individual item information may include a designed service life of the fuel cell offered for sale, the user-input-information acceptor may accept, from the user, information on an expected usage period of a fuel cell, and the matching processor may select, when the usable period of the fuel cell offered for sale, which is estimated by the usable-period estimator, satisfies the expected usage period provided by the user, the fuel cell offered for sale as a matching candidate.

According to the invention described in (3), it is possible to select a fuel cell offered for sale, which offers an estimated usable period satisfying an expected usage period, as a matching candidate, allowing the user to select an appropriate fuel cell satisfying the expected usage period from among the matching candidates.

(4) In the fuel-cell secondary-use determination system described in (3), the usable-period estimator may correct the usable period based on a frequency of generation of electric power by a fuel cell, which is expected by the user at a place of reuse.

According to the invention described in (4), it is possible to select a further appropriate fuel cell offered for sale in accordance with a frequency of generation of electric power at a place of reuse as a matching candidate, allowing the user to select a further appropriate fuel cell in accordance with a frequency of generation of electric power at a place of reuse from among the matching candidates.

(5) In the fuel-cell secondary-use determination system described in (3) or (4), the remaining-value determiner may determine a residual price of the fuel cell offered for sale, the user-input-information acceptor may accept information on a budget of the user, and the matching processor may select, when the residual price of the fuel cell offered for sale is equal to or below the budget of the user, the fuel cell offered for sale as a matching candidate.

According to the invention described in (5), it is possible to select a fuel cell offered for sale falling within a range of a budget of a user as a matching candidate, allowing the user to select an appropriate fuel cell satisfying the budget from among the matching candidates.

(6) In the fuel-cell secondary-use determination system described in any one of (3) to (5), the matching processor may select, when a requested output expected by the user at a place of reuse is higher than a predetermined output capability, a fuel cell offered for sale, which has a relatively lower degree of degradation, as a matching candidate in a prioritized manner.

According to the invention described in (6), it is possible to select, when a requested output capability expected at a place of reuse is higher, a fuel cell offered for sale, which satisfies a requested output capability and which has a lower degree of degradation, as a matching candidate, allowing the user to select a further appropriate fuel cell satisfying an application at a place of reuse from among the matching candidates.

(7) In the fuel-cell secondary-use determination system described in any one of (3) to (6), the matching processor may select, when the requested output capability provided by the user is satisfied by summing present output capabilities of a plurality of the fuel cells offered for sale with each other, the plurality of fuel cells offered for sale as a matching candidate.

According to the invention described in (7), it is possible to select a plurality of fuel cells offered for sale, which satisfy a requested output capability provided by a user, as a matching candidate, by summing present output capabilities of the plurality of fuel cells offered for sale with each other, allowing the user to select a combination of a plurality of fuel cells satisfying the requested output capability from among the matching candidates.

(8) In the fuel-cell secondary-use determination system described in (7), the matching processor may select, when a value of an output variation of a fuel cell, which is expected by the user at a place of reuse, is smaller than a predetermined value, a combination of a plurality of the fuel cells offered for sale as a matching candidate regardless of the degrees of degradation, and may select, when a value of an output variation of a fuel cell, which is expected by the user at a place of reuse, is equal to or above the predetermined value, a combination of a plurality of the fuel cells offered for sale, each of which has a relatively lower degree of degradation, and among which there is a relatively smaller difference in degree of degradation, as a matching candidate.

According to the invention described in (8), when a value of an output variation of a fuel cell, which is expected at a place of reuse, is smaller, it is possible to select a combination of a plurality of fuel cells offered for sale as a matching candidate regardless of the degrees of degradation. Furthermore, when a value of an output variation of a fuel cell, which is expected at a place of reuse, is greater, it is possible to select a combination of a plurality of fuel cells offered for sale, each of which has a relatively lower degree of degradation, and among which there is a relatively smaller difference in degree of degradation, as a matching candidate. Thereby, when a fuel cell is applied to a stationary-use type power supply, where its output variation is smaller, for example, there is no problem even when the fuel cell is degraded to some extent, and, furthermore, there is no problem even when a plurality of fuel cells vary in degree of degradation from each other, allowing the user to select a combination of fuel cells in accordance with this application regardless of the degrees of degradation. Furthermore, when a fuel cell is applied to a commercial vehicle such as a truck, where its output variation is greater, for example, it is preferable that the fuel cell is not so degraded, and, furthermore, it is preferable that there is no or less difference in degree of degradation among a plurality of fuel cells, allowing the user to select a combination of fuel cells, each of which has a relatively lower degree of degradation, and among which there is a relatively smaller difference in degree of degradation in accordance with this application.

(9) In the fuel-cell secondary-use determination system described in any one of (3) to (8), the usable-period estimator may calculate the usable period by subtracting, from the designed service life, either a life-consumed period due to a lowered output capability or a life-consumed period due to film degradation.

According to the invention described in (9), subtracting part of the life, which is consumed due to a lowered output capability or film degradation from the designed service life makes it possible to calculate a further accurate estimated usable period, allowing the user to select a further appropriate fuel cell satisfying the request by the user as a matching candidate.

(10) In the fuel-cell secondary-use determination system described in (9), the usable-period estimator may calculate the usable period by subtracting, from the designed service life, the longer of either the life-consumed period due to a lowered output capability or the life-consumed period due to film degradation.

According to the invention described in (10), subtracting, from the designed service life, the longer of either a life-consumed period due to a lowered output capability or a life-consumed period due to film degradation, makes it possible to calculate a further accurate estimated usable period, allowing the user to select a further appropriate fuel cell satisfying the request by the user as a matching candidate.

(11) In the fuel-cell secondary-use determination system described in (9) or (10), the life-consumed period due to a lowered output capability may be calculated by multiplying the designed service life by a ratio of a difference between an initial output capability and a present output capability to a difference between an initial output capability and a final output capability (output capability at end of designed service life).

According to the invention described in (11), subtracting a life-consumed period calculated based on an amount of decrease in output from a designed service life makes it possible to calculate a further accurate estimated usable period, allowing the user to select a further appropriate fuel cell satisfying the request by the user as a matching candidate.

(12) In the fuel-cell secondary-use determination system described in any one of (9) to (11), the life-consumed period due to film degradation may be calculated by multiplying the designed service life by a film degradation rate.

According to the invention described in (12), subtracting, from a designed service life, a life-consumed period calculated based on a film degradation rate makes it possible to calculate a further accurate estimated usable period, allowing the user to select a further appropriate fuel cell satisfying the request by the user as a matching candidate.

(13) In the fuel-cell secondary-use determination system described in (5), the seller-input-information acceptor may be able to accept information on a desired selling price by the seller, and the remaining-value determiner may determine, when the seller input information includes the information on the desired selling price, the desired selling price as a residual price of the fuel cell offered for sale, and may calculate, when the seller input information does not include the information on the desired selling price, a residual price of the fuel cell offered for sale based on the seller input information.

According to the invention described in (13), it is possible to achieve matching of an appropriate fuel cell in accordance with information on a desired selling price by a seller, making it possible to achieve matching of a fuel cell that satisfies both the seller and a user.

(14) In the fuel-cell secondary-use determination system described in (5) or (13), the remaining-value determiner may calculate a residual price of the fuel cell offered for sale by multiplying an initial price of the fuel cell offered for sale by a ratio of an estimated usable period estimated by the usable-period estimator with respect to the designed service life of the fuel cell offered for sale.

According to the invention described in (14), it is possible to calculate a residual price of a fuel cell offered for sale based on an estimated usable period, making it possible to set a further appropriate residual price, and making it possible to achieve matching of a further appropriate fuel cell.

(15) Furthermore, the present invention provides a fuel-cell secondary-use determination method including: accepting, from a seller, seller input information, which includes individual item information including a type and an identifier of a fuel cell offered for sale, information on a usage period to date, information on output performance including a present output capability, and information on degradation; and determining a remaining value of the fuel cell offered for sale based on the information on the usage period, the information on the output performance, and the information on the degradation.

According to the invention described in (15), it is possible to achieve effects similar to those of the invention described in (1).

### Effects of the Invention

According to the present invention, it is possible to provide a technology that makes it possible to evaluate a reuse value of a fuel cell based on a state of degradation of the fuel cell.

### BRIEF DESCRIPTION OF THE DRAWINGS

FIG. 1 is a block diagram illustrating a configuration of a fuel-cell secondary-use determination system according to a first embodiment;

FIG. 2 is a view illustrating an example of time series data stored in a time-series-data storage according to the first embodiment;

FIG. 3 is a view illustrating an example of management information stored in a management-information storage according to the first embodiment;

FIG. 4 is a view illustrating an example of display information displayed on a display terminal according to the first embodiment;

FIG. 5 is a flowchart illustrating a procedure of processing in the fuel-cell secondary-use determination system according to the first embodiment;

FIG. 6 is a block diagram illustrating a configuration of a fuel-cell secondary-use determination system according to a second embodiment;

FIG. 7 is a view illustrating an example of display information displayed on an input display terminal according to the second embodiment;

FIG. 8 is a view illustrating an example of demand information stored in a demand-information storage according to the second embodiment;

FIG. 9 is a view illustrating an example of management information stored in a management-information storage according to the second embodiment;

FIG. 10 is a view illustrating an example of display information displayed on the input display terminal according to the second embodiment when a user requests a plurality of fuel cells;

FIG. 11 is a view illustrating an example of management information stored in the management-information storage according to the second embodiment when the user requests a plurality of fuel cells; and

FIG. 12 is a flowchart illustrating a procedure of processing in the fuel-cell secondary-use determination system according to the second embodiment.

### PREFERRED MODE FOR CARRYING OUT THE INVENTION

Embodiments of the present invention will now be described herein in detail with reference to the accompanying drawings. Note that, to describe a second embodiment, like reference numerals designate identical or corresponding components to those in a first embodiment, and their descriptions are thus appropriately omitted.

### First Embodiment

A fuel-cell secondary-use determination system according to a first embodiment is a system that makes it possible to evaluate a reuse value of a fuel cell based on a state of degradation of the fuel cell. More specifically, the fuel-cell secondary-use determination system according to the present embodiment is, for example, a system that accepts, from a seller such as an electric power supply business operator, seller input information, which includes individual item information, information on a usage period, information on output performance, and information on degradation of a fuel cell offered for sale, for example, and determines a remaining value of the fuel cell offered for sale based on the seller input information.

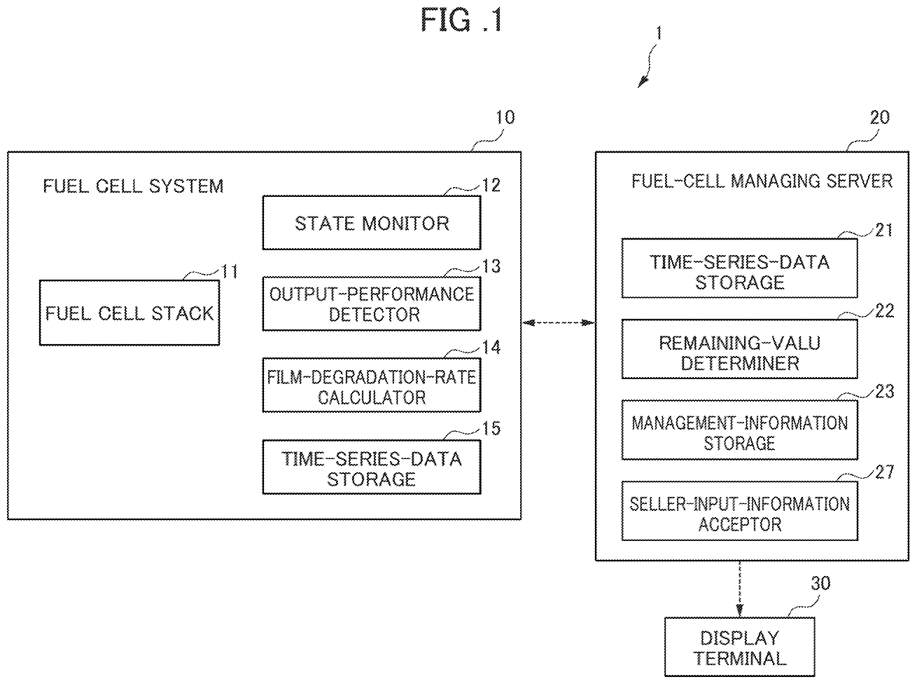

FIG. 1 is a block diagram illustrating a configuration of a fuel-cell secondary-use determination system 1 according to the first embodiment. As illustrated in FIG. 1, the fuel-cell secondary-use determination system 1 according to the present embodiment includes a fuel cell system 10, a fuel-cell managing server 20, and a display terminal 30. The fuel cell system 10, the fuel-cell managing server 20, and the display terminal 30 are communicably coupled to each other via a non-illustrated communication network such as the Internet or a mobile phone network conforming to 4G and 5G standards, for example.

The fuel cell system 10 and the fuel-cell managing server 20 each include a microprocessor including a central processing unit (CPU), random access memory (RAM), a read-only memory (ROM), and an input/output interface (I/O), for example. The CPU executes each program read from the ROM or a storage, reads information from the RAM, the ROM, and the storage when the program is executed, writes information onto the RAM and the storage, and executes exchanging of signals with a non-illustrated communication unit. In this manner, hardware and software (a program) cooperate with each other to achieve processing in the present embodiment.

The fuel cell system 10 is mounted on a fuel cell vehicle, for example. The fuel cell system 10 includes a fuel cell stack 11, a state monitor 12, an output-performance detector 13, a film-degradation-rate calculator 14, and a time-series-data storage 15.

The fuel cell stack 11 has a stack structure in which several tens to several hundreds of fuel battery cells are stacked with each other, for example. In each of the fuel battery cells, a membrane electrode assembly (MEA) is sandwiched between a pair of separators. The membrane electrode assembly includes two electrodes, i.e., an anode electrode (a negative electrode) and a cathode electrode (a positive electrode), and a solid polymer electrolyte film sandwiched between the electrodes. Normally, both the electrodes each include a catalytic layer that is in contact with the solid polymer electrolyte film, in which oxidation-reduction reaction occurs, and a gas diffusion layer that is in contact with the catalytic layer. The fuel cell stack 11 causes electrochemical reaction to occur to generate electric power when fuel gas (hydrogen gas) is supplied into an anode flow channel formed on an anode electrode side, and oxidant gas (air) is supplied into a cathode flow channel formed on a cathode electrode side.

The fuel cell stack 11 (hereinafter simply referred to as a fuel cell) in the present embodiment is a new fuel cell stack that has been recently produced, a used fuel cell stack, or a fuel cell stack that has been produced a long time ago. A seller offers for sale such a used fuel cell stack as the fuel cell stack 11 according to the present embodiment. The fuel-cell secondary-use determination system 1 according to the present embodiment evaluates a reuse value of the used fuel cell stack based on a state of degradation of the used fuel cell stack. Note that a fuel cell stack used in the present specification is synonymous with a fuel cell.

The state monitor 12 acquires information on the history of operation of the fuel cell. Specifically, when the fuel cell receives a start instruction and generates electric power, for example, the state monitor 12 acquires an output voltage and an output current of the fuel cell per predetermined period of time such as at an interval of ten seconds to monitor the fuel cell. The state monitor 12 uses, for example, a temperature sensor disposed in a cooling channel in the fuel cell to acquire a temperature in an operation environment (a temperature of a coolant) per predetermined period of time such as at an interval of ten seconds to monitor the fuel cell. The state monitor 12 uses, for example, a pressure sensor disposed in a gas channel in the fuel cell to acquire gas pressure per predetermined period of time such as at an interval of ten seconds to monitor the fuel cell. The state monitor 12 uses, for example, a humidity sensor disposed in the fuel cell stack 11 to acquire humidity in the operation environment per predetermined period of time such as at an interval of ten seconds to monitor the fuel cell stack 11.

Furthermore, during a period from when the fuel cell starts generation of electric power to when the fuel cell stops generation of electric power, the state monitor 12 acquires information on a usage period to date including hours of generation of electric power to monitor the fuel cell. When generation of electric power is stopped, the state monitor 12 executes an inspection for a cross leak in the fuel cell to acquire an amount of a cross leak from a result of the inspection for a cross leak to monitor the fuel cell. Note herein that an amount of a cross leak in the fuel cell is an amount of gas leaked between the anode and the cathode via the electrolyte film. An amount of a cross leak is one type of information on the history of operation, and is also one type of information on degradation of a fuel cell.

Note that the state monitor 12 sends various types of parameters acquired as described above to the output-performance detector 13, the film-degradation-rate calculator 14, and the time-series-data storage 15 described later, as information on the history of operation of the fuel cell.

The output-performance detector 13 detects output performance of the fuel cell. Specifically, the output-performance detector 13 detects output performance including an initial output (or initial output capability) and a present output (or present output capability), for example, of the fuel cell based on an output voltage and an output current of the fuel cell, which are acquired by the state monitor 12 described above. Furthermore, the output-performance detector 13 detects an amount of decrease in output from the initial output capability to the present output capability as information on output performance and one type of information on degradation of the fuel cell. The information on output performance and the information on degradation detected by the output-performance detector 13 are sent to the time-series-data storage 15 described later.

The film-degradation-rate calculator 14 calculates a film degradation rate of the electrolyte film in the fuel cell based on the information on the history of operation of the fuel cell, which is acquired by the state monitor 12 described above. The film degradation rate calculated by the film-degradation-rate calculator 14 is sent to the time-series-data storage 15 described later as one type of information on degradation of the fuel cell.

Note herein that an assumed reason of chemical degradation of an electrolyte film in a fuel cell is that there are cleaving reaction on a polymer backbone and unzipping reaction where decomposition advances from terminals of the backbone. It is indicated that, when a polymer backbone is cleaved, two terminals are newly created at the cleaved position, and the number of starting points of unzipping reaction increases exponentially in a multiplying manner. Therefore, a film degradation rate of an electrolyte film in a fuel cell is modeled with an exponential function.

Specifically, the film-degradation-rate calculator 14 calculates a film degradation rate F by following a mathematical equation (1) described below that is modeled with the exponential function.

[Mathematical Equation 1]

F(t)=a{exp(b·T)−1} Mathematical Equation (1)

In the mathematical equation (1) described above, a and b are factors determined based on the specification of the fuel cell, a temperature in an operation environment (a temperature of a coolant), gas pressure, humidity in the operation environment, an output voltage, and an output current. Furthermore, in the mathematical equation (1) described above, T is hours of generation of electric power (h) during which the fuel cell has generated electric power. As for the specification of the fuel cell, a temperature in an operation environment (a temperature of a coolant), gas pressure, humidity in the operation environment, an output voltage, an output current, and hours of generation of electric power, data acquired by the state monitor 12 is used as described above.

The time-series-data storage 15 stores, as time series data, the information on the history of operation of the fuel cell, which is acquired by the state monitor 12, the information on the output performance of the fuel cell, which is detected by the output-performance detector 13, the film degradation rate calculated by the film-degradation-rate calculator 14, the amount of decrease in output, which is detected by the output-performance detector 13, and the information on the degradation including an amount of a cross leak, which is acquired by the state monitor 12. The time series data stored in the time-series-data storage 15 is linked, when the fuel cell is offered for sale, to the individual item information including the type and the identifier of the fuel cell, and sent to the fuel-cell managing server 20 described later.

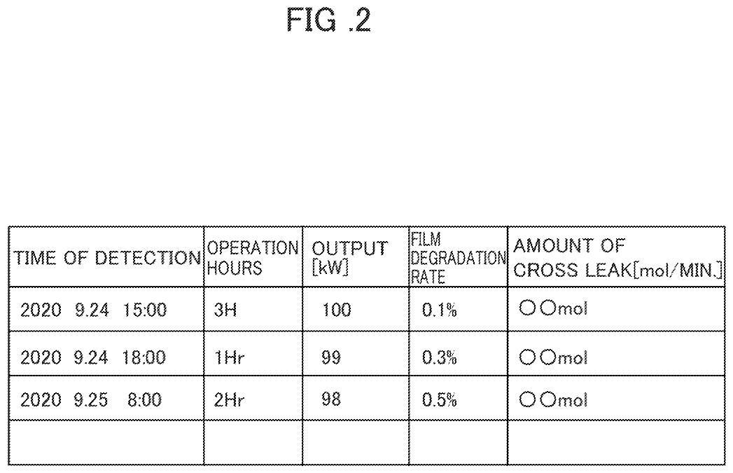

FIG. 2 is a view illustrating an example of time series data stored in the time-series-data storage 15 according to the present embodiment. In the present example, as illustrated in FIG. 2, the time-series-data storage 15 stores, per time of detection, operation hours (hours of generation of electric power) serving as information on a usage period to date, which is one type of information on the history of operation of a fuel cell, a present output capability serving as information on output performance, and a film degradation rate and an amount of a cross leak serving as information on degradation.

The fuel-cell managing server 20 includes a time-series-data storage 21, a remaining-value determiner 22, a management-information storage 23, and a seller-input-information acceptor 27.

The seller-input-information acceptor 27 accepts, when a fuel cell is offered for sale, time series data described above, which is linked to the individual item information including the type and the identifier of the fuel cell. That is, the seller-input-information acceptor 27 accepts, from a seller, seller input information, which includes individual item information including a type and an identifier of a fuel cell offered for sale, information on the history of operation including information on a usage period to date including hours of generation of electric power, information on output performance including a present output capability, and information on degradation including a film degradation rate, an amount of decrease in output, and an amount of a cross leak.

Furthermore, the seller-input-information acceptor 27 may accept, from the seller, information on a desired selling price of the fuel cell offered for sale. In this case, information on a desired selling price may be determined as a residual price when the remaining-value determiner 22 described later determines a remaining value. Thereby, it is possible to achieve matching of an appropriate fuel cell in accordance with information on a desired selling price by a seller.

The time-series-data storage 21 stores the time series data described above, which is linked to the individual item information including the type and the identifier of the fuel cell, which is accepted by the seller-input-information acceptor 27. That is, the time-series-data storage 21 stores the information on the history of operation, the information on the output performance, and the information on the degradation of the fuel cell offered for sale, which are respectively linked to the individual item information including the type and the identifier of the fuel cell.

The remaining-value determiner 22 determines a remaining value of the fuel cell offered for sale based on the information on the usage period, the information on the output performance, and the information on the degradation of the fuel cell. As described above, the information on the usage period, the information on the output performance, and the information on the degradation of the fuel cell are all stored in the time-series-data storage 21. Information on a usage period of a fuel cell is one type of information on the history of operation of the fuel cell offered for sale, which is stored in the time-series-data storage 21, and, specifically, corresponds to hours of generation of electric power, for example. Information on degradation of a fuel cell includes a film degradation rate, an amount of decrease in output, and an amount of a cross leak. A result of determination of the remaining value by the remaining-value determiner 22 is sent to the management-information storage 23 described later as information on a remaining value of the fuel cell.

The remaining-value determiner 22 determines a remaining value of the fuel cell offered for sale as a residual price, for example. The remaining-value determiner 22 may determine, when the seller-input-information acceptor 27 accepts information on a desired selling price of a fuel cell offered for sale from a seller, information on the desired selling price as a residual price. When seller input information does not include information on a desired selling price, a residual price of the fuel cell offered for sale may be calculated based on the seller input information. Thereby, in accordance with a desired value of a seller, it is possible to set a residual price satisfying the desired value.

The management-information storage 23 stores the information on the remaining value determined by the remaining-value determiner 22. Specifically, the management-information storage 23 links the information on the remaining value determined by the remaining-value determiner 22 to the individual item information including the type and the identifier of the fuel cell and the time series data described above, and stores the linked information and the data.

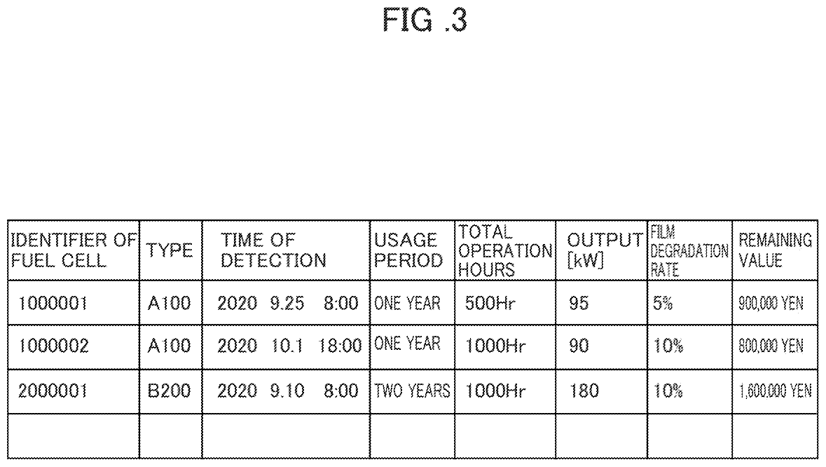

FIG. 3 is a view illustrating an example of management information stored in the management-information storage 23 according to the present embodiment. In the present example, as illustrated in FIG. 3, the management-information storage 23 stores a time of detection, a usage period, total operation hours, an output, an output capability, a film degradation rate, and a remaining value, per type and identifier of a fuel cell. As the remaining value, a residual price is determined and stored.

The display terminal 30 is used by a user of the system such as a seller, allowing the user to access the fuel-cell managing server 20. A seller, for example, is able to allow, when the seller stops operation of a fuel cell and sells the fuel cell to a dealer, for example, the display terminal 30 to display the management information stored in the management-information storage 23. That is, with the display terminal 30, it is possible to acquire and display the information on the remaining value linked to the individual item information and the time series data of the fuel cell offered for sale.

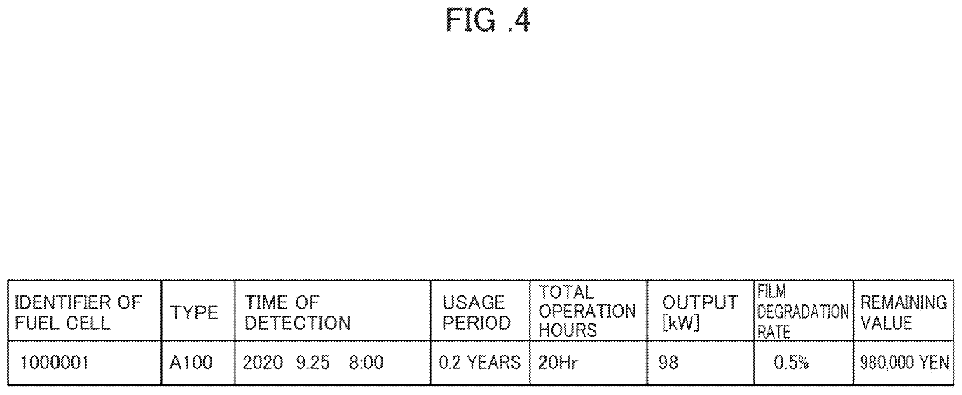

FIG. 4 is a view illustrating an example of display information displayed on the display terminal 30 according to the present embodiment. In the present example, as illustrated in FIG. 4, the display terminal 30 displays a time of detection, a usage period, total operation hours, an output, an output capability, a film degradation rate, and a residual price, per type and identifier of a fuel cell. In this way, a user of the fuel-cell secondary-use determination system 1 according to the present embodiment is able to check such information as described above through the display terminal 30.

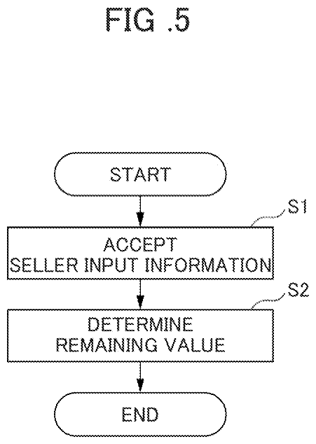

Next, a procedure of processing in the fuel-cell secondary-use determination system 1 according to the present embodiment will now be described herein. FIG. 5 is a flowchart illustrating the procedure of processing in the fuel-cell secondary-use determination system 1 according to the present embodiment. The processing is repeatedly executed at a predetermined control cycle, for example.

At step S1, seller input information is accepted. Specifically, the seller-input-information acceptor 27 that the fuel-cell managing server 20 includes accepts, from a seller, seller input information, which includes individual item information including a type and an identifier of a fuel cell offered for sale, information on the history of operation including information on a usage period to date including hours of generation of electric power, information on output performance including a present output capability, and information on degradation including film degradation, an amount of decrease in output, and an amount of a cross leak. After that, the processing proceeds to step S2.

At step S2, a remaining value of the fuel cell offered for sale is determined. Specifically, the remaining-value determiner 22 that the fuel-cell managing server 20 includes determines a remaining value of the fuel cell offered for sale based on the information on the usage period, the information on the output performance, and the information on the degradation. After performing the determination, the processing ends.

Note that, as the fuel-cell secondary-use determination system 1 according to the present embodiment executes the processing, a fuel-cell secondary-use determination method according to the present embodiment is achieved. That is, step S1 in the processing described above corresponds to a seller-input-information accepting step in the fuel-cell secondary-use determination method according to the present embodiment, and step S2 in the processing described above corresponds to a remaining-value determining step.

According to the present embodiment, it is possible to achieve effects described below. The fuel-cell secondary-use determination system 1 according to the present embodiment includes the seller-input-information acceptor 27 that accepts, from a seller, seller input information, which includes individual item information including a type and an identifier of a fuel cell offered for sale, information on a usage period to date, information on output performance including a present output capability, and information on degradation. Furthermore, the remaining-value determiner 22 that determines a remaining value of the fuel cell offered for sale based on the information on the usage period, the information on the output performance, and the information on the degradation is further included. Thereby, according to the present embodiment, it is possible to determine a remaining value of a fuel cell based on a state of degradation, per fuel cell offered for sale, making it possible to appropriately evaluate a reuse value of the fuel cell.

Furthermore, it is known that an actual life and durable years of a fuel cell largely depends on its use history, operation environment, and other factors pertaining to the fuel cell, for example. Therefore, there is a possibility that even a fuel cell having just passed its durable years set beforehand still has a remaining value at that point in time. Discarding such a fuel cell still having a remaining value based on a fact that its life and durable years set beforehand have just passed wastes the remaining value, leaving some issues in terms of effective use of resources. In response to these issues, according to the present embodiment, it is possible to determine a reuse value of a used fuel cell when the used fuel cell is to be reused, making it possible to select an appropriate fuel cell in accordance with a place (an object, a destination, a target, etc.) of reuse. Eventually, according to the present embodiment, even when a fuel cell having passed its durable years as a vehicle fuel cell is diverted for its application to a stationary application, for example, it is possible to easily select a place (an object, a destination, a target, etc.) of reuse and to set a selling price by an intermediary agent.

### Second Embodiment

A fuel-cell secondary-use determination system according to a second embodiment is a system that makes it possible to evaluate a reuse value of a fuel cell based on a state of degradation of the fuel cell, and to achieve matching of an appropriate fuel cell in accordance with a place (an object, a destination, a target, etc.) of reuse. More specifically, it is a system that accepts, from a seller of a fuel cell such as an electric power supply business operator, seller input information, which includes individual item information, information on a usage period, information on output performance, and information on degradation of the fuel cell offered for sale, for example, and determines a remaining value of the fuel cell offered for sale based on the seller input information. Furthermore, it is a system that accepts, from a user such as an electric power supply business operator, user input information, which includes information on a requested output capability for a fuel cell, for example, and selects an appropriate fuel cell in accordance with a place (an object, a destination, a target, etc.) of reuse based on the user input information, as a matching candidate.

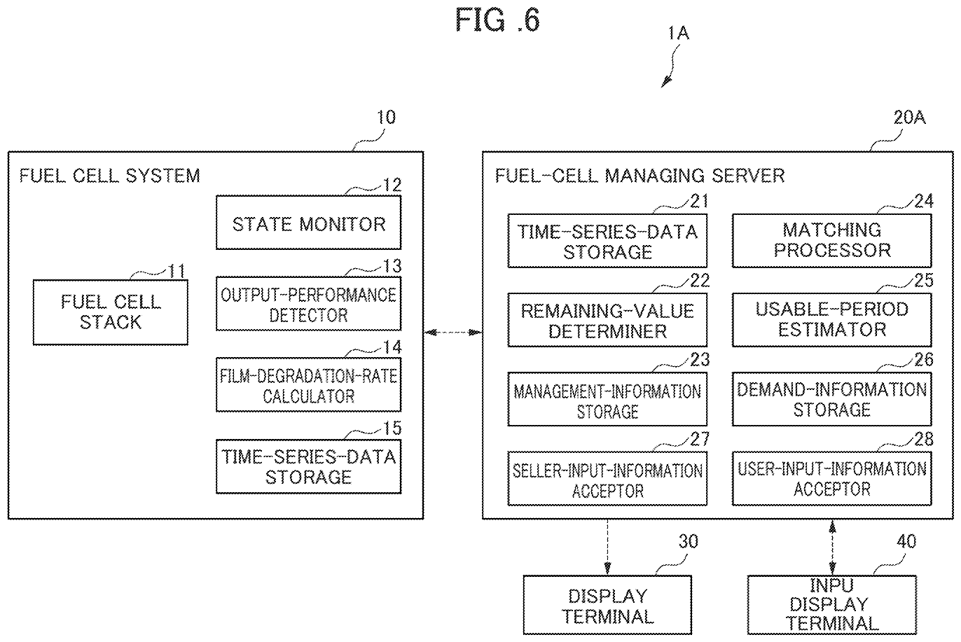

FIG. 6 is a block diagram illustrating a configuration of a fuel-cell secondary-use determination system 1A according to the present embodiment. As illustrated in FIG. 6, the present embodiment has a configuration similar to the configuration of the first embodiment, excluding that, compared with the first embodiment, a fuel-cell managing server 20A has a different configuration, and an input display terminal 40 is included. Specifically, a difference from the first embodiment is that the fuel-cell managing server 20A according to the present embodiment further includes a matching processor 24, a usable-period estimator 25, a demand-information storage 26, and a user-input-information acceptor 28.

Note that, similar to the first embodiment, the fuel cell system 10, the fuel-cell managing server 20A, the display terminal 30, and the input display terminal 40 are communicably coupled to each other via a non-illustrated communication network such as the Internet or a mobile phone network conforming to 4G and 5G standards, for example.

The user-input-information acceptor 28 accepts, from a user, user input information, which includes information on a requested output capability for a fuel cell. User input information may include information on a place of reuse (an application) by the user, information on an expected usage period of the fuel cell at the place of reuse, information on a frequency of generation of electric power at the place of reuse, and information on a budget of the user. Furthermore, when a user requests a plurality of fuel cells, information on the required number of units may be included.

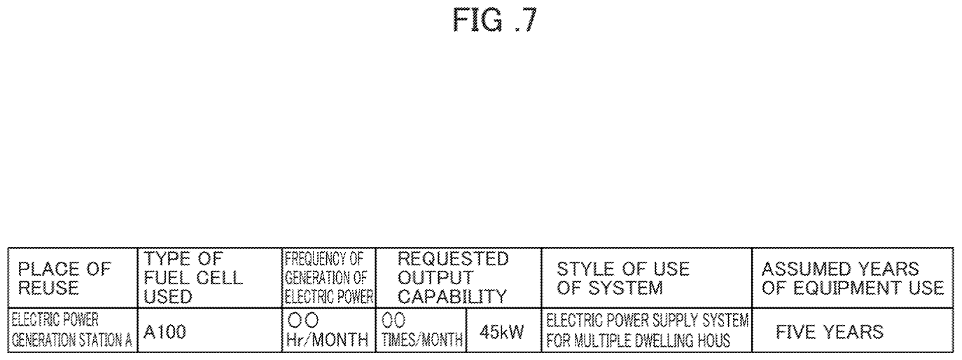

Note herein that FIG. 7 is a view illustrating an example of user input information, which is displayed on the input display terminal 40 according to the present embodiment. In the present example, as illustrated in FIG. 7, the input display terminal 40 displays, as user input information, a place of reuse of a fuel cell, a type of the fuel cell, a frequency of generation of electric power, a requested output capability, a style of use of a system, and expected years of equipment use. The user input information is inputted by the user via the input display terminal 40. The user is able to check the user input information on the input display terminal 40.

The matching processor 24 selects, when a present output capability of a fuel cell offered for sale satisfies the requested output capability provided by the user, the fuel cell offered for sale as a matching candidate. Therefore, as the user-input-information acceptor 28 accepts information on a requested output capability for a fuel cell, which the user requests, the matching processor 24 selects a fuel cell offered for sale, which offers a present output capability satisfying the requested output capability, as a matching candidate. Thereby, the user is able to check the fuel cell offered for sale, which is selected as a matching candidate, on the input display terminal 40, making it possible to select the fuel cell satisfying the requested output capability from among the matching candidates. Note that a requested output capability provided by a user may be an exact requested output capability expected at a place of reuse or an output capability greater than the requested output capability in accordance with the request by the user.

A prerequisite in matching by the matching processor 24 is that, as described above, a present output capability of a fuel cell offered for sale satisfies a requested output capability provided by a user. However, matching may be performed by adding an additional condition as described below.

The matching processor 24 may select, when an estimated usable period calculated by the usable-period estimator 25 described later satisfies an expected usage period provided by a user, the fuel cell offered for sale as a matching candidate. In this case, as the user-input-information acceptor 28 accepts information on an expected usage period by a user at a place of reuse, the matching processor 24 selects a fuel cell offered for sale, which offers an estimated usable period satisfying the expected usage period, as a matching candidate. Thereby, the user is able to check the fuel cell offered for sale, which is selected as a matching candidate, on the input display terminal 40, making it possible to select the fuel cell satisfying the expected usage period from among the matching candidates.

The matching processor 24 may select, when a residual price of a fuel cell offered for sale is equal to or below a budget of a user, the fuel cell offered for sale as a matching candidate. In this case, when the user-input-information acceptor 28 accepts information on a budget of the user, the matching processor 24 selects a fuel cell offered for sale, which offers a residual price satisfying the budget of the user, as a matching candidate. Thereby, the user is able to check the fuel cell offered for sale, which is selected as a matching candidate, on the input display terminal 40, making it possible to select the fuel cell satisfying the budget from among the matching candidates.

The matching processor 24 may select, when a requested output capability expected by the user at the place of reuse is higher than a predetermined output capability, a fuel cell offered for sale, which has a relatively lower degree of degradation, as a matching candidate in a prioritized manner. Note herein that a degree of degradation is determined based on information on degradation including a film degradation rate, an amount of decrease in output, and an amount of a cross leak described above. The greater the film degradation rate, the amount of decrease in output, and/or the amount of a cross leak, the greater the degree of degradation. A relatively smaller degree of degradation means that a degree of degradation of a fuel cell offered for sale is relatively smaller among fuel cells offered for sale selected as matching candidates. The predetermined output capability is set beforehand based on a relationship between an output and a degree of degradation.

In this case, as the user-input-information acceptor 28 accepts information on a requested output capability for a fuel cell, which the user requests, the matching processor 24 selects a fuel cell offered for sale, which has a relatively smaller degree of degradation, from among fuel cells offered for sale, each of which offers a present output capability satisfying the requested output capability, as a matching candidate in a prioritized manner. At this time, a fuel cell having a smallest degree of degradation is displayed at the highest position on the input display terminal 40, for example. Thereby, the user is able to check the fuel cell offered for sale, which is selected as a matching candidate, on the input display terminal 40, making it possible to select the fuel cell, which satisfies the requested output capability, and which has a smaller degree of degradation, from among the matching candidates.

The matching processor 24 may also select, when a requested output capability provided by a user is satisfied by summing present output capabilities of a plurality of fuel cells offered for sale with each other, the plurality of fuel cells offered for sale as a matching candidate. In this case, as the user-input-information acceptor 28 accepts information on a requested output capability for a fuel cell, which the user requests, the matching processor 24 selects a plurality of fuel cells offered for sale, which satisfy the requested output capability provided by the user by summing present output capabilities of the plurality of fuel cells offered for sale with each other, as a matching candidate. For example, when two fuel cells each having a present output capability of 50 kW are offered for sale, and when a user requests a fuel cell having an output capability thereof of 100 kW, the matching processor 24 selects, as a matching candidate, the two fuel cells offered for sale, each of which has a present output capability of 50 kW, to serve as a fuel cell having an output capability thereof of 100 kW. Thereby, the user is able to check a plurality of fuel cells offered for sale, which are selected as a matching candidate, on the input display terminal 40, making it possible to select a combination of a plurality of fuel cells, which satisfies the requested output capability, from among the matching candidates. Note that, as there may be a case where fuel cells are not able to be coupled to each other due to their types, the matching processor 24 takes into account such types to select a plurality of fuel cells offered for sale as a matching candidate.

When a requested output capability provided by a user is satisfied by summing present output capabilities of a plurality of fuel cells offered for sale with each other, and when a value of an output variation of a fuel cell expected by the user at the place of reuse is smaller than a predetermined value, the matching processor 24 may select a combination of a plurality of fuel cells offered for sale as a matching candidate without depending on their degrees of degradation. Reasons of this are, when a fuel cell is applied to a stationary-use type power supply, where its output variation is smaller, for example, there is no problem even when the fuel cell is degraded to some extent, and, furthermore, there is no problem even when a plurality of fuel cells vary in degree of degradation from each other. Note herein that an output variation is calculated from a difference between a maximum output value and a minimum output value of a fuel cell, which are expected at a place of reuse, for example. The degree of degradation is as described above. The predetermined value is set beforehand based on a relationship between an output variation and a degree of degradation.

In this case, as the user-input-information acceptor 28 accepts information on a requested output capability and information on a place of reuse for a fuel cell, which the user requests, the matching processor 24 selects a plurality of fuel cells offered for sale, which satisfy the requested output capability provided by the user by summing present output capabilities of the plurality of fuel cells offered for sale with each other, as a matching candidate without depending on their degrees of degradation. Thereby, the user is able to check fuel cells offered for sale, which are selected as a matching candidate, on the input display terminal 40, making it possible to select a combination of fuel cells satisfying the requested output capability from among the matching candidates, regardless of their degrees of degradation.

When a requested output capability provided by a user is satisfied by summing present output capabilities of a plurality of fuel cells offered for sale with each other, and when a value of an output variation of a fuel cell expected by the user at the place of reuse is equal to or above the predetermined value described above, the matching processor 24 may select a combination of a plurality of fuel cells offered for sale, each of which has a relatively lower degree of degradation, and among which there is a relatively smaller difference in degree of degradation, as a matching candidate. Reasons of this are, when a fuel cell is applied to a commercial vehicle such as a truck, where its output variation is greater, for example, a preferable fuel cell is one that is not so degraded, and, furthermore, it is preferable that there is no or less difference in degree of degradation among a plurality of fuel cells. A relatively lower degree of degradation and a relatively smaller difference in degree of degradation mean, among fuel cells offered for sale selected as matching candidates, a combination of fuel cells offered for sale, each of which has a relatively lower degree of degradation, and among which there is a smaller difference in degree of degradation, among the selected plurality of matching candidates.

In this case, as the user-input-information acceptor 28 accepts information on a requested output capability and information on a place of reuse for a fuel cell, which the user requests, the matching processor 24 selects a plurality of fuel cells offered for sale, each of which has a relatively lower degree of degradation, among which there is a relatively smaller difference in degree of degradation, and which satisfy the requested output capability provided by the user by summing present output capabilities of the plurality of fuel cells offered for sale with each other, as a matching candidate. Thereby, the user is able to check fuel cells offered for sale, which are selected as a matching candidate, on the input display terminal 40, making it possible to select a combination of the fuel cells, each of which has a lower degree of degradation, among which there is a smaller difference in degree of degradation, and which satisfies the requested output capability, from among the matching candidates.

The usable-period estimator 25 estimates a usable period of a fuel cell offered for sale based on the individual item information and the information on the degradation of the fuel cell offered for sale. Furthermore, the usable-period estimator 25 may calculate an estimated usable period of a fuel cell offered for sale based on information on output performance, information on a requested output capability, and information on a place of reuse, in addition to the individual item information and the information on the degradation of the fuel cell offered for sale. The usable-period estimator 25 may calculate an estimated usable period of a fuel cell offered for sale when the fuel cell offered for sale, which is selected as a matching candidate by the matching processor 24, is used at a place of reuse, and may calculate an estimated usable period that is to be used, as a condition for matching by the matching processor 24. The estimated usable period calculated by the usable-period estimator 25 is displayed on the input display terminal 40, and sent to and stored in the management-information storage 23.

The usable-period estimator 25 may subtract, from a designed service life, either a life-consumed period due to a lowered output capability or a life-consumed period due to film degradation to calculate an estimated usable period. Thereby, it is possible to calculate a further accurate estimated usable period, making it possible to select a further appropriate fuel cell in accordance with a request by a user as a matching candidate.

Otherwise, the usable-period estimator 25 may calculate an estimated usable period by subtracting, from a designed service life, the longer of either a life-consumed period due to a lowered output capability or a life-consumed period due to film degradation. Thereby, it is possible to calculate a further accurate estimated usable period, making it possible to select a further appropriate fuel cell in accordance with a request by a user as a matching candidate. Note that, in the present embodiment, a designed service life is included in individual item information on a fuel cell offered for sale and stored in the time-series-data storage 21.

Note herein that a life-consumed period due to a lowered output capability is calculated by multiplying a designed service life by a ratio of a difference between an initial output capability and a present output capability to a difference between an initial output capability and a final output capability of a fuel cell. Specifically, a life-consumed period due to a lowered output capability is calculated in accordance with a mathematical equation (2) described below. An initial output capability, a final output capability, and a present output capability are stored, as information on output performance, in the time-series-data storage 21. In this way, it is possible to calculate a further accurate estimated usable period by subtracting a life-consumed period calculated based on an amount of decrease in output from a designed service life. Note that a final output capability is a designed output in a degraded state when a designed service life has passed.

[Mathematical Equation 2]

Life-consumed period due to lowered output=(Initial output capability−Present output capability)/(Initial output−Final output)×Designed service life Mathematical Equation (2)

A life-consumed period due to film degradation is calculated by multiplying a designed service life by a film degradation rate. Specifically, a life-consumed period due to film degradation is calculated in accordance with a mathematical equation (3) described below. A film degradation rate is calculated by the film-degradation-rate calculator 14 described above, and is stored in the time-series-data storage 21. In this way, it is possible to calculate a further accurate estimated usable period by subtracting a life-consumed period calculated based on a film degradation rate from a designed service life.

[Mathematical Equation 3]

Life-consumed period due to film degradation=Design durable period×Film degradation rate Mathematical Equation (3)

Furthermore, the usable-period estimator 25 may correct an estimated usable period described above based on a frequency of generation of electric power by a fuel cell, which is expected by a user at a place of reuse. Specifically, when the user-input-information acceptor 28 accepts information on a frequency of generation of electric power by a fuel cell at a place of reuse, the usable-period estimator 25 corrects the estimated usable period estimated as described above based on the frequency of generation of electric power at the place of reuse. Thereby, it is possible to achieve matching of a further appropriate fuel cell in accordance with a frequency of generation of electric power at a place of reuse. Therefore, the user is able to check the fuel cell offered for sale further appropriately selected as a matching candidate on the input display terminal 40, making it possible to select a further appropriate fuel cell in accordance with a frequency of generation of electric power at a place of reuse from among the matching candidates.

The demand-information storage 26 stores user input information, which includes information on a requested output capability for a fuel cell, and which is accepted by the user-input-information acceptor 28 from the user, as demand information. Demand information may include information on a place of reuse (an application) by a user, information on an expected usage period of the fuel cell at the place of reuse, information on a frequency of generation of electric power at the place of reuse, and information on a budget of the user. Furthermore, when a user requests a plurality of fuel cells, information on the required number of units may be included.

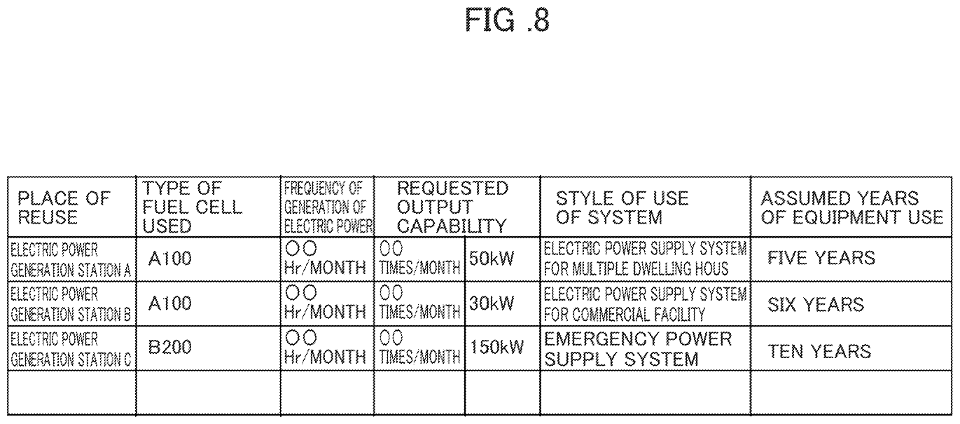

Note herein that FIG. 8 is a view illustrating an example of demand information stored in the demand-information storage 26 according to the present embodiment. In the present example, as illustrated in FIG. 8, a place of reuse by a user, a type of a fuel cell, a frequency of generation of electric power, a requested output capability, a style of use of a system, and expected years of equipment use are stored. The user is able to check such demand information on the input display terminal 40.

Note that the remaining-value determiner 22 according to the present embodiment may calculate, differently from the first embodiment, a residual price of a fuel cell offered for sale by multiplying an initial price of the fuel cell offered for sale by a ratio of an estimated usable period calculated by the usable-period estimator 25 described above with respect to a designed service life of the fuel cell offered for sale. Specifically, the remaining-value determiner 22 according to the present embodiment may calculate a residual price in accordance with a mathematical equation (4) described below. Thereby, it is possible to calculate a residual price of a fuel cell offered for sale based on an estimated usable period, making it possible to set a further appropriate residual price.

[Mathematical Equation 4]

Residual price=Initial price×Estimation usable period/Designed service life Mathematical Equation (4)

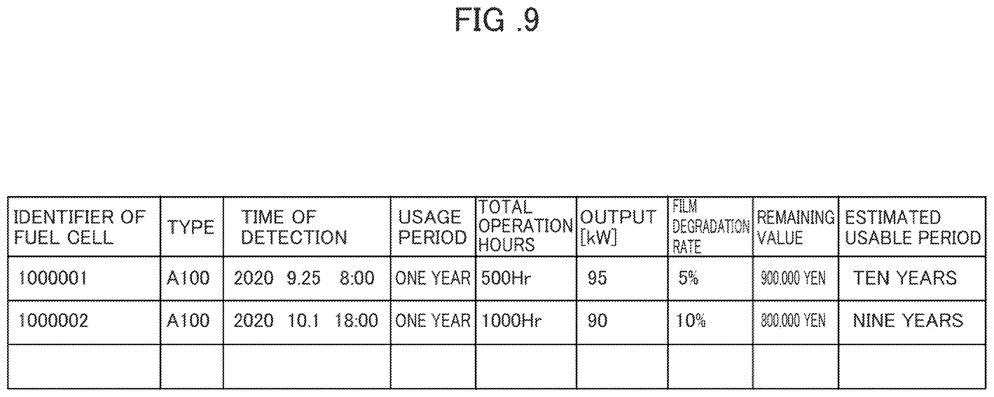

Furthermore, the management-information storage 23 according to the present embodiment stores, differently from the first embodiment, an estimated usable period calculated as described above. Note herein that FIG. 9 is a view illustrating an example of management information stored in the management-information storage 23 according to the present embodiment. In the present example, as illustrated in FIG. 9, a time of detection, a usage period, total operation hours, an output, an output capability, a film degradation rate, a residual price, and an estimated usable period are stored per type and identifier of a fuel cell. Such management information is displayed on the input display terminal 40. In this way, the matching processor 24 causes a fuel cell offered for sale, which satisfies a request by a user, to be selected and displayed. At this time, it is possible to refer to an estimated usable period when the selected fuel cell is used in a system at a place of reuse.

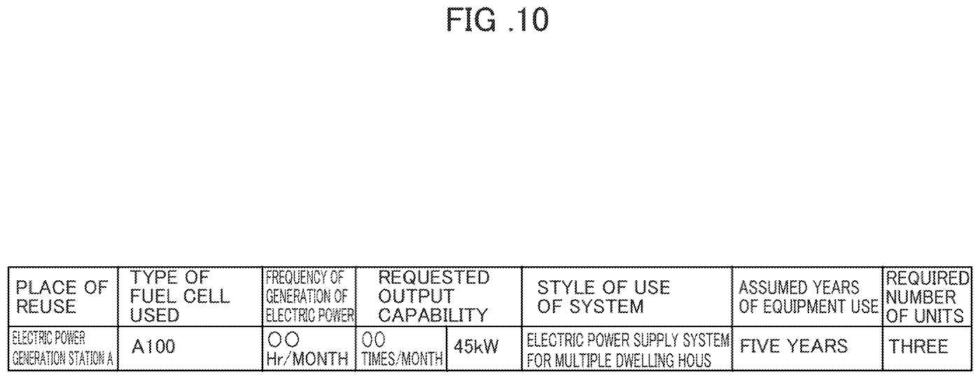

Next, a case when a user requests a plurality of fuel cells will now be described herein. FIG. 10 is a view illustrating an example of display information displayed on the input display terminal 40 according to the present embodiment when a user requests a plurality of fuel cells. In the example illustrated in FIG. 10, a place of reuse, a type of a fuel cell, a frequency of generation of electric power, a requested output capability, a style of use of a system, expected years of equipment use, and a required number of units are displayed on the input display terminal 40. In this way, when a user requests a plurality of fuel cells, the user is able to input the required number of units as user input information via the input display terminal 40, and the user is able to check the user input information on the input display terminal 40.

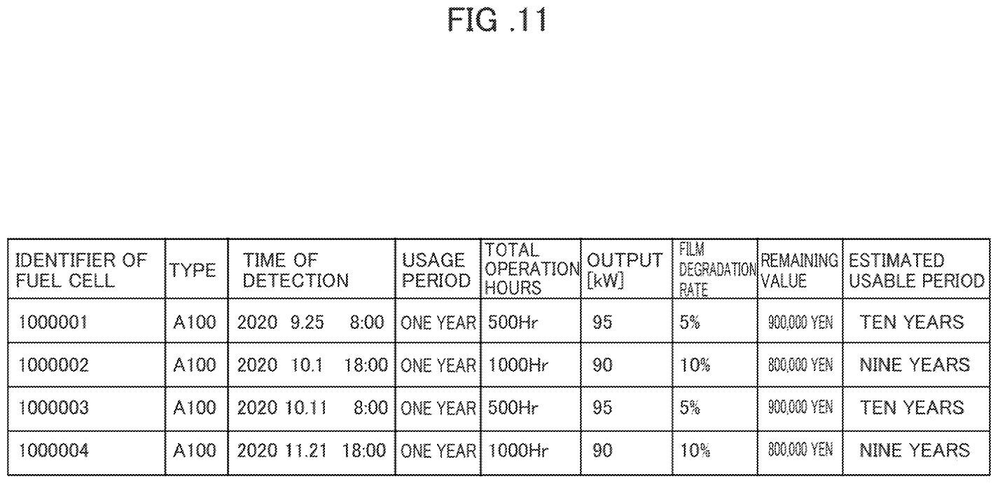

FIG. 11 is a view illustrating an example of management information stored in the management-information storage 23 according to the present embodiment when a user requests a plurality of fuel cells. In the present example, as illustrated in FIG. 11, a time of detection, a usage period, total operation hours, an output, an output capability, a film degradation rate, a remaining value, and an estimated usable period are stored per type and identifier of a fuel cell. In this way, when a user requests a plurality of fuel cells, a plurality of fuel cells offered for sale, which satisfy the request, are selected as matching candidates by the matching processor 24, and are displayed on the input display terminal 40. The user is thus able to select a combination of desired fuel cells.

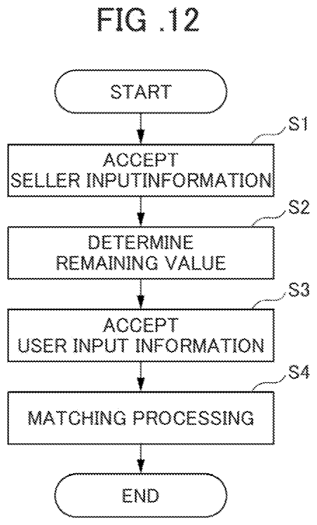

Next, a procedure of processing in the fuel-cell secondary-use determination system 1A according to the present embodiment will now be described herein. FIG. 12 is a flowchart illustrating the procedure of processing in the fuel-cell secondary-use determination system 1A according to the present embodiment. The processing is repeatedly executed at a predetermined control cycle, for example.

At step S1, seller input information is accepted. Specifically, the seller-input-information acceptor 27 that the fuel-cell managing server 20A includes accepts, from a seller, seller input information, which includes individual item information including a type and an identifier of a fuel cell offered for sale, information on a usage period to date, information on output performance including a present output capability, and information on degradation. After that, the processing proceeds to step S2.

At step S2, a remaining value of the fuel cell offered for sale is determined. Specifically, the remaining-value determiner 22 that the fuel-cell managing server 20A includes determines a remaining value of the fuel cell offered for sale based on the information on the usage period, the information on the output performance, and the information on the degradation. After that, the processing proceeds to step S3.

At step S3, user input information is accepted. Specifically, the user-input-information acceptor 28 that the fuel-cell managing server 20 includes accepts, from a user, user input information, which includes information on a requested output capability for a fuel cell. After that, the processing proceeds to step S4.

At step S4, matching processing is executed. Specifically, the matching processor 24 that the fuel-cell managing server 20A includes selects a fuel cell offered for sale as a matching candidate when a present output capability of the fuel cell offered for sale satisfies the requested output capability provided by the user. After that, the processing ends.

Note that, although, in the flowchart illustrated in FIG. 12, seller input information is accepted, a remaining value is determined, and then user input information is accepted, the present invention is not limited to execute this procedure of processing. For example, user input information may first be accepted, and, after that, seller input information may be accepted, and a remaining value may be determined.

According to the present embodiment, it is possible to achieve effects described below, in addition to those effects achieved with the first embodiment. The fuel-cell secondary-use determination system 1A according to the present embodiment includes the user-input-information acceptor that accepts, from a user, user input information, which includes information on a requested output capability for a fuel cell, and further includes the matching processor that selects, when a present output capability of the fuel cell offered for sale satisfies the requested output capability provided by the user, the fuel cell offered for sale as a matching candidate. Thereby, according to the present embodiment, it is possible to select a fuel cell offered for sale, which satisfies a request by a user, as a matching candidate, and the user is able to select a desired fuel cell from among the matching candidates.

Note that the present invention is not limited to the embodiments described above. The present invention still includes variations and improvements, for example, that fall within the scope of the present invention, as long as it is possible to achieve the object of the present invention.

### EXPLANATION OF REFERENCE NUMERALS

1, 1A Fuel-cell secondary-use determination system
10 Fuel cell system
11 Fuel cell stack
12 State monitor
13 Output-performance detector
14 Film-degradation-rate calculator
15 Time-series-data storage
20, 20A Fuel-cell managing server
21 Time-series-data storage
22 Remaining-value determiner
23 Management-information storage
24 Matching processor
25 Usable-period estimator
26 Demand-information storage
27 Seller-input-information acceptor
28 User-input-information acceptor
30 Display terminal
40 Input display terminal

1. A fuel-cell secondary-use determination system comprising:
a seller-input-information acceptor that accepts seller input information from a seller, the seller input information including individual item information including a type and an identifier of a fuel cell offered for sale, information on a usage period to date, information on output performance including a present output capability, and information on degradation; and
a remaining-value determiner that determines a remaining value of the fuel cell offered for sale based on the information on the usage period, the information on the output performance, and the information on the degradation.

2. The fuel-cell secondary-use determination system according to claim 1, further comprising:
a user-input-information acceptor that accepts user input information from a user, the user input information including information on a requested output capability for a fuel cell; and
a matching processor that selects, when the present output capability of the fuel cell offered for sale satisfies the requested output capability provided by the user, the fuel cell offered for sale as a matching candidate.

3. The fuel-cell secondary-use determination system according to claim 2,
further comprising a usable-period estimator that estimates a usable period of the fuel cell offered for sale based on the individual item information and the information on the degradation,
wherein
the individual item information includes a designed service life of the fuel cell offered for sale,
the user-input-information acceptor accepts, from the user, information on an expected usage period of a fuel cell, and
the matching processor selects, when the usable period of the fuel cell offered for sale, the usable period being estimated by the usable-period estimator, satisfies the expected usage period provided by the user, the fuel cell offered for sale as a matching candidate.

4. The fuel-cell secondary-use determination system according to claim 3, wherein the usable-period estimator corrects the usable period based on a frequency of generation of electric power by a fuel cell expected by the user at a place of reuse.

5. The fuel-cell secondary-use determination system according to claim 3, wherein
the remaining-value determiner determines a residual price of the fuel cell offered for sale,
the user-input-information acceptor accepts information on a budget of the user, and
the matching processor selects, when the residual price of the fuel cell offered for sale is equal to or below the budget of the user, the fuel cell offered for sale as a matching candidate.

6. The fuel-cell secondary-use determination system according to claim 3, wherein the matching processor selects, when a requested output capability expected by the user at a place of reuse is higher than a predetermined output capability, a fuel cell offered for sale, the fuel cell offered for sale having a relatively lower degree of degradation, as a matching candidate in a prioritized manner.

7. The fuel-cell secondary-use determination system according to claim 3, wherein the matching processor selects, when the requested output capability provided by the user is satisfied by summing present output capabilities of a plurality of the fuel cells offered for sale with each other, the plurality of fuel cells offered for sale as a matching candidate.

8. The fuel-cell secondary-use determination system according to claim 7, wherein the matching processor
selects, when a value of an output variation of a fuel cell, the output variation being expected by the user at a place of reuse, is smaller than a predetermined value, a combination of a plurality of the fuel cells offered for sale as a matching candidate regardless of the degrees of degradation, and
selects, when a value of an output variation of a fuel cell, the output variation being expected by the user at a place of reuse, is equal to or above the predetermined value, a combination of a plurality of the fuel cells offered for sale, each of which has a relatively lower degree of degradation, and among which there is a relatively smaller difference in degree of degradation, as a matching candidate.

9. The fuel-cell secondary-use determination system according to claim 3, wherein the usable-period estimator calculates the usable period by subtracting, from the designed service life, either a life-consumed period due to a lowered output capability or a life-consumed period due to film degradation.

10. The fuel-cell secondary-use determination system according to claim 9, wherein the usable-period estimator calculates the usable period by subtracting, from the designed service life, the longer of either the life-consumed period due to a lowered output capability or the life-consumed period due to film degradation.

11. The fuel-cell secondary-use determination system according to claim 9, wherein the life-consumed period due to a lowered output capability is calculated by multiplying the designed service life by a ratio of a difference between an initial output capability and a present output capability to a difference between an initial output capability and a final output capability.

12. The fuel-cell secondary-use determination system according to claim 9, wherein the life-consumed period due to film degradation is calculated by multiplying the designed service life by a film degradation rate.

13. The fuel-cell secondary-use determination system according to claim 5, wherein
the seller-input-information acceptor is able to accept information on a desired selling price by the seller, and
the remaining-value determiner
determines, when the seller input information includes the information on the desired selling price, the desired selling price as a residual price of the fuel cell offered for sale, and
calculates, when the seller input information does not include the information on the desired selling price, a residual price of the fuel cell offered for sale based on the seller input information.

14. The fuel-cell secondary-use determination system according to claim 5, wherein the remaining-value determiner calculates a residual price of the fuel cell offered for sale by multiplying an initial price of the fuel cell offered for sale by a ratio of an estimated usable period estimated by the usable-period estimator with respect to the designed service life of the fuel cell offered for sale.

15. A fuel-cell secondary-use determination method comprising:
accepting seller input information from a seller, the seller input information including individual item information including a type and an identifier of a fuel cell offered for sale, information on a usage period to date, information on output performance including a present output capability, and information on degradation; and
determining a remaining value of the fuel cell offered for sale based on the information on the usage period, the information on the output performance, and the information on the degradation.
